(19) United States
(12) Patent Application Publication
(10) Pub. No.: US 2013/0087718 A1
(43) Pub. Date: Apr. 11, 2013

(54) CONFOCAL FLUORESCENCE LIFETIME IMAGING SYSTEM

(71) Applicants: Erwen Mei, Belle Mead, NJ (US); Ahmad Yekta, Somerset, NJ (US)

(72) Inventors: Erwen Mei, Belle Mead, NJ (US); Ahmad Yekta, Somerset, NJ (US)

(73) Assignee: GE HEALTHCARE BIO-SCIENCES CORP., PISCATAWAY, NJ (US)

(21) Appl. No.: 13/704,741

(22) PCT Filed: Jun. 27, 2011
(86) PCT No.: PCT/SE2011/050846

§ 371 Date: Dec. 17, 2012

Related U.S. Application Data
(60) Provisional application No. 61/358,960, filed on Jun. 28, 2010.

(51) Int. Cl. G01N 21/64

(52) U.S. Cl. CPC G01N 21/645
USPC 250/458.1; 250/216

(57) ABSTRACT

A confocal fluorescence lifetime imaging (FLIM) system comprising a pulsed tuneable excitation light source arranged to provide excitation radiation to an illumination area on a target, scanning means for scanning the illumination area across the target, and at least one detector for detecting fluorescent emission from the target, wherein the pulsed light source comprises a line forming unit arranged to form a line shaped illumination area of pulsed excitation light on the target, and wherein the detector comprises shutter means arranged to operate in synchronization with the pulsed light source enabling detection of time-resolved fluorescent emission intensity from the target.

### FIELD OF THE INVENTION

The present invention relates to a confocal fluorescence lifetime imaging system, and more in detail to a multi wavelength high speed confocal fluorescence lifetime imaging system.

### BACKGROUND OF THE INVENTION

Generally, when researching tiny regions of interest on a sample, researchers often employ a fluorescence microscope to observe the sample. The microscope may be a conventional wide-field, structured light or confocal microscope. The optical configuration of such a microscope typically includes a light source, illumination optics, objective lens, sample holder, imaging optics and a detector. Light emitted from the light source illuminates the region of interest on the sample after propagating through the illumination optics and the objective lens. Microscope objective forms a magnified image of the object that can be observed via eyepiece, or in case of a digital microscope, the magnified image is captured by the detector and sent to a computer for live observation, data storage, and further analysis.

In wide-field microscopes, the target is imaged using a conventional wide-field strategy as in any standard microscope, and collecting the fluorescence emission. Generally, the fluorescent-stained or labeled sample is illuminated with excitation light of the appropriate wavelength(s) and the emission light is used to obtain the image; optical filters and/or dichroic mirrors are used to separate the excitation and emission light.

Confocal microscopes utilize specialized optical systems for imaging. In the simplest system, a laser operating at the excitation wavelength of the relevant fluorophore is focused to a point on the sample; simultaneously, the fluorescent emission from this illumination point is imaged onto a small-area detector. Any light emitted from all other areas of the sample is rejected by a small pinhole located in front to the detector which transmits on that light which originates from the illumination spot. The excitation spot is scanned across the sample in a raster pattern to form a complete image. There are a variety of strategies to improve and optimize speed and throughput which are well known to those skilled in this area of art.

Line-confocal microscopes are a modification of the confocal microscope, wherein the fluorescence excitation source is a laser beam; however, the beam is focused onto a narrow line on the sample, rather than a single point. The fluorescence emission is then imaged on the optical detector through the slit which acts as the spatial filter. Light emitted from any other areas of the sample remains out-of-focus and as a result is blocked by the slit. To form a two-dimensional image the line is scanned across the sample while simultaneously reading the line camera. This system can be expanded to use several lasers and several cameras simultaneously by using an appropriate optical arrangement.

One type of line confocal microscope is disclosed in U.S. Pat. No. 7,335,898, which is incorporated by reference, wherein the optical detector is a two dimensional sensor element operated in a rolling line shutter mode whereby the mechanical slit can be omitted and the overall system design may be simplified.

The technology of fluorescence lifetime imaging (FLIM) has been around for about a decade. Briefly speaking, fluorescence lifetime is the average time that a fluorophor spends in the excited state. Fluorescence lifetime is sensitive to the environment surrounding the fluorophor and does not normally depend on concentration, excitation light intensity, quantum efficiency and alignment of the optical system. In other words, fluorescence lifetime is a molecular property the value of which is independent of the measuring instrument and can be replicated across time and different laboratories. FLIM, which represent the measurement of fluorescence lifetime at each spatially resolvable element of an image, can provide a map of the molecular environment of a fluorophor.

FLIM can be applied to the mapping of cell parameters such as pH, ion concentrations, and oxygen. A major area of application is to measurement of protein-protein interactions through fluorescence resonance energy transfer (FRET). Attempts at measuring FRET from intensity images are beset with major errors that remain partly uncorrected despite laborious calibration methods. FLIM allows for direct calculation of FRET efficiencies without such errors.

Fluorescence lifetime can be measured by two popular methods: frequency domain and time-domain. FLIM based on time-domain methods such as time correlated single photon counting (TCSPC) and a confocal laser point scanning microscopy can offer confocal images of the sample, but suffers from long data acquisition times, from tens of seconds to minutes. Methods based on widefield microscopy are faster but cannot provide confocal images.

Application of single wavelength lasers to imaging needs multiple lasers in the range of 400-800 nm for different samples. The supercontinuum source offers the advantage of a single light source that can be easily tuned to the needed wavelength.

To date a variety of methods for FLIM and time-resolved fluorescence (TRF) intensity imaging have been developed.

### SUMMARY OF THE INVENTION

The object of the invention is to provide a new confocal fluorescence lifetime imaging system, which overcomes one or more drawbacks of the prior art. This is achieved by the confocal fluorescence lifetime imaging system as defined in the independent claims.

One advantage with such a confocal fluorescence lifetime imaging system is the increased speed while providing confocal images.

Another advantage of the present system is that it is less complex compared to present point scan confocal FLIM systems.

Further scope of applicability of the present invention will become apparent from the detailed description given hereinafter. However, it should be understood that the detailed description and specific examples while indicating preferred embodiments of the invention are given by way of illustration only. Various changes and modifications within the spirit and scope of the invention will become apparent to those skilled in the art from the detailed description below.

### BRIEF DESCRIPTION OF THE DRAWINGS

FIG. 1 is a schematic block diagram of one embodiment of a confocal fluorescence lifetime imaging system in accordance with the invention.

FIG. 2 shows another embodiment of the invention.

FIG. 3 shows another embodiment of the invention.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

According to one embodiment, there is provided a confocal fluorescence lifetime imaging (FLIM) system comprising a pulsed tuneable excitation light source arranged to provide excitation radiation to an illumination area on a target, scanning means for scanning the illumination area across the target, and at least one detector for detecting fluorescent emission from the target. The pulsed light source comprises a line forming unit arranged to form a line shaped illumination area of pulsed excitation light on the target, and the detector comprises shutter means arranged to operate in synchronization with the pulsed light source enabling detection of time-resolved fluorescence intensity from the target.

According to one embodiment, the shutter means 116 is a gated image intensifier with suitable characteristics. Alternatively the shutter means 116 is any type of mechanism that is capable of controlling the fluorescent emission from the target impinging onto the sensor in synchronization with the pulsed light source.

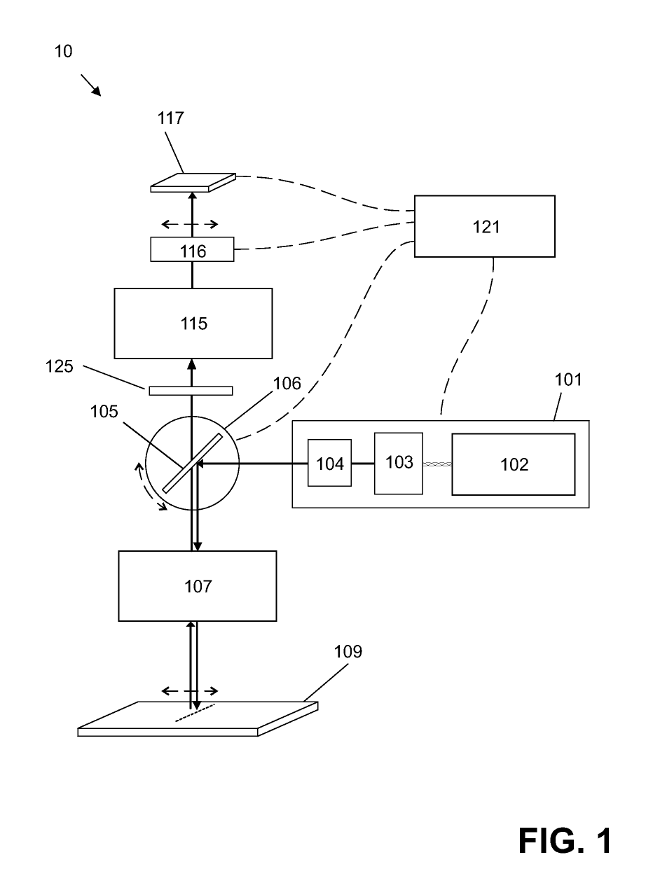

FIG. 1 illustrates a block diagram of the essential components of one embodiment of a confocal FLIM system 10. The disclosed confocal FLIM system 10 comprises a pulsed tuneable light source 101 with a line forming unit 104, a scanning unit 105, an objective lens 107, a sample/target position 109, imaging optics 115, shutter means 116, a two dimensional sensor unit 117, and control unit 121. The system may contain other components as would ordinarily be found in confocal and wide field microscopes. The following sections describe these and other components in more detail. For a number of the components there are multiple potential embodiments. In general the preferred embodiment depends upon the target application.

The pulsed tuneable light source 101 can be any tuneable light source capable of delivering pulsed excitation light over a range of wavelengths to the target. According to one embodiment the light source 101 comprises a pulsed broad band laser light source 102 such as a pulsed supercontinuum laser and a wavelength selection unit 103. The wave length selection unit 103 may e.g. be a prism or grating based monochromator arrangement with a wavelength selection slit, or a filter wheel with excitation filters. Between the different components in the light source, the light may be coupeled as a free space beam of the appropriate diameter, direction and degree of collimation or via fiber optic light delivery system.

The light beam that is emitted by: the light source 101, is formed to a line shaped beam by the line forming unit 104. Preferred embodiments of the line-forming unit 104 include, but are not limited to, a Powell lens (as described in U.S. Pat. No. 4,826,299, incorporated herein by reference). The shape of the second conic-cylindrical surface is preferably specified to achieve both uniform illumination to within 10% over the range AO and more than 80% transmission of the laser light through the objective 107. Alternative line forming units 104 such as cylindrical lenses, diffraction gratings, and holographic elements can also be used.

In the embodiment disclosed in FIG. 1, the scanning means for scanning the illumination area across the target is comprised of a scanning minor unit 105 which provides the scanning of the line shaped excitation light beam in the focal plane of the objective across the field of view of the microscope. According to one embodiment, the scanning minor unit 105 is a mechanically driven scanning mirror unit 105 that comprises a minor that can be tilted about an axis transverse to the plane of FIG. 1. The angle of the tilt is set by an actuator 106. According to one embodiment, the minor 105 is comprised of a narrow minor centered on, or axially offset from, the rear of the objective 107. The geometry and reflective properties of said narrow minor may be as follows:

Width ˜ 1/10 times the diameter of the rear aperture of the objective.

Length ˜1.6 times the diameter of the rear aperture of the objective.

Optically flat.

Highly reflective 300 nm to 800 nm.

These particular properties of the minor provide several key advantages:

(1) It makes it possible to use a single minor for all excitation wavelengths. Relative to a multiband dichroic minor this greatly increases the flexibility in adapting the system to a wide range of lasers.

(2) It uses the rear aperture of the objective at its widest point. This leads to the lowest achievable level of diffraction which in turn yields the narrowest achievable width of the line of laser illumination at the sample.

The system can also be used with an optional dichroic minor. The design of the dichroic minor will be such that the radiation of all wavelengths from the excitation light source are efficiently reflected, and that light in the wavelength range corresponding to fluorescence emission is efficiently transmitted. A multi band minor based on Rugate technology is a preferred embodiment.

The scanning unit 105 is arranged to direct the light beam on the back aperture of the objective 107 and to scan the beam. In order to view the sample in different magnifications, the microscope may comprise two or more objectives 107 of different magnification, e.g. 10× and 20× or the like. The light emitted or reflected from the illumination area on the target/sample 109 is collected by the objective lens 107, filtered by a filter unit 125, and then an image of the illumination area is formed by the typical imaging optics 115 on the two dimensional sensor unit 117. The filter unit 125 is selected to let the excitation fluorescence wavelengths go through to the detector unit 117 and to block the excitation radiation wavelength(s). In order to register the fluorescence life time of the excited fluorophor s along the line shaped illumination area, shutter means 116 is arranged in the light path between the imaging optics and the sensor unit 117. The operation of the shutter means 116 is controlled by the system control unit 121 to be synchronized with the pulsed excitation light source, at a predetermined delay in order to retrieve the lifetime of the fluorophores that are excited along the line shaped illumination area on the target 109. In the embodiment of FIG. 1, the shutter means is a 2d shutter means such as a gated image intensifier with an optical area corresponding to the area of the sensor unit 117. The gated intensifier should then be arranged in a position optically conjugated to the imaging area on the sample and it may comprise imaging optics so that the image intensifier is arranged to provide a corresponding conjugate image on the image plane of the sensor unit 117 (In the case the gated intensifier does not comprise imaging optics, then imaging optics needs to be inserted between 116 and 117, so that the image intensifier is arranged to provide a corresponding conjugate image on the image plane of the sensor 117). According to another embodiment the shutter means may be a deflection type shutter which may be arranged to deflect the light emitted or reflected from the sensor unit in the “closed state” and to direct the light onto the sensor unit in the open state, such as a digital micro mirror device, an acousto-optic deflector or the like.

In the embodiment of FIG. 1, the two dimensional sensor unit 117 is comprised of any suitable optical sensor array or camera capable of detecting the fluorescent light and generating an image, and that may be operated in a rolling line shutter mode. The fluorescent emission that is delivered to the rolling line shutter detection area of the sensor unit 117 after having passed the shutter means 116 is detected by reading the signals from the pixels located within the line shutter detection area of the sensor unit. The detection area of the sensor unit that is located outside of the rolling line shutter detection area of the sensor unit is disregarded during operation in rolling line shutter mode in order to reject optical signals received outside of the rolling line shutter detection area such as stray light and out of plane fluorescence. As the illumination area is scanned across the target/sample 109 using the scanning mirror unit 105, the rolling line shutter detection area of the sensor unit 117 is moved in synchronization to maintain the optical conjugation with the illumination line on the sample.

As is schematically indicated in FIG. 1, the line scanning microscope system 10 comprises a control unit 121, which may be integrated, partly integrated or external to the microscope system 10. The control unit 121 may e.g. be a computer comprising necessary software to control the system 10 and to collect image data from the sensor unit 117. It may further comprise image processing capabilities to e.g. to enable subsequent analysis of the acquired images etc.

One main feature of the control unit 121 is to establish synchronization between the scanning unit 105 and the rolling line shutter operation of the sensor unit 117. The control unit 121 is arranged to control scan trajectory for the scanning unit 105 with respect to rolling line shutter operation of the sensor unit 117, and vice versa, as well as the mutual timing As mentioned above, the scanning trajectory of the scanning mirror 105 is controllable by controlling the actuation of the actuator 106 in accordance with a set of scan parameters defining the scanning trajectory, comprising scan origin, scan endpoint, scan velocity, scan acceleration rate, scan deceleration rate, etc. The rolling line shutter operation may be controlled in accordance with a set of shutter parameters defining the optical detection operation of the sensor unit, comprising line width, shutter velocity, shutter origin and endpoint etc.

In order to obtain high quality images, the rolling line shutter operated registration of the fluorescence signal resulting from the scan of the line shaped light beam 101 across the field of view need to be synchronized. This synchronization can be broken into two categories: temporal sync and spatial sync.

Temporal synchronization means that the velocity of the scanning line of the fluorescence signal resulting from the scanning is equal to the velocity of the rolling line shutter of the sensor unit 117 for any exposure time within an allowed range.

Spatial synchronization means that the fluorescence signal resulting from the scanning during image acquisition is always located in the center of rolling line shutter detection area of the sensor unit 117.

Hence the system control unit 121 is connected to and arranged to control the operation of the light source 101, the scanning unit 105, the shutter means 116 and the sensor unit 117 according to predetermined synchronization to provide high quality line confocal FLIM.

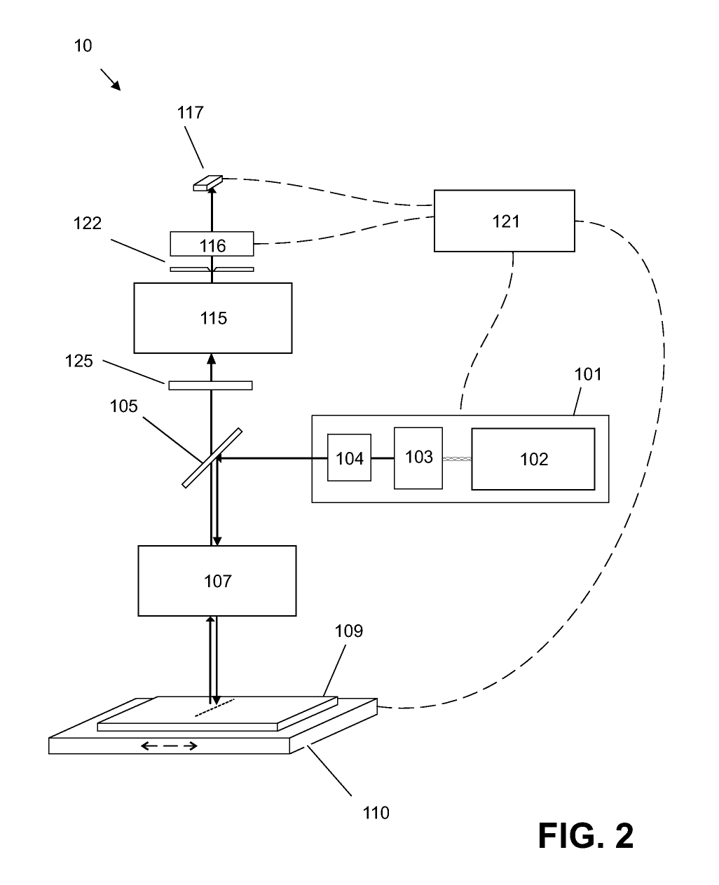

According to one embodiment, schematically disclosed in FIG. 2, the scanning means for scanning the illumination area across the target is arranged to translate the sample with respect to “non-scanning” system optics. In this embodiment, the line illumination path of the system, comprising the pulsed tuneable excitation light source 101 with line forming means 104 and the objective 107 is essentially identical to the embodiment of FIG. 1 with the difference that the scanning unit for scanning the illumination beam is omitted and replaced by a stationary mirror arrangement 105 for directing the line shaped excitation illumination into the back aperture of the objective 107. As the illumination area on the target 109, in this embodiment is stationary with respect to the optics of the system 10, the 2D sensor unit may be replaced by a 1D or rectangular sensor unit 117 and the shape and the size of the sensor unit detection area is selected to be equal or smaller than an image of optically conjugated illumination line on the sample 109, alternatively, the shape and the size of the sensor unit detection area that is used for registration is controlled by a line slit 122, which optionally may be of controllable width.

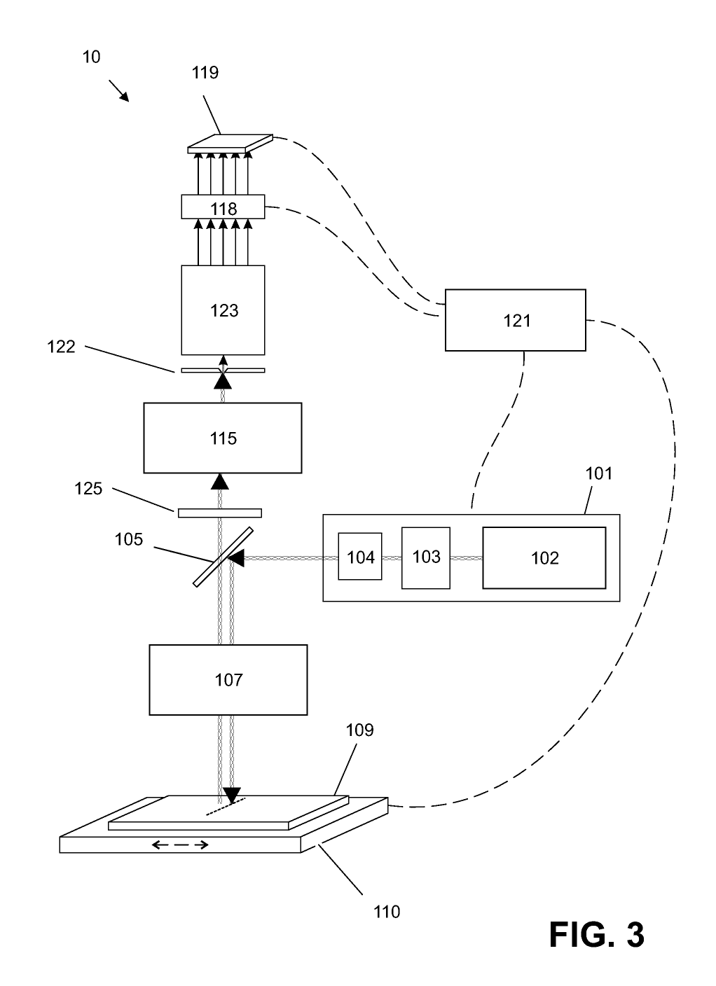

According to one embodiment, schematically disclosed in FIG. 3 the pulsed excitation light source is a broad band light source arranged to provide excitation radiation of a predetermined range of wavelengths whereas the detector comprises a line spectral imaging unit for providing spectrum resolved FLIM capable of separating the fluorescent emission from the target 109 spectrally. Alternatively, the wavelength selection unit 103 may be arranged to controllably select a predetermined wavelength spectra from a broader spectra emitted by the pulsed light source 102. The spectrum of the pulsed excitation light is selected to excite two or more different fluorophores in the target/sample 109 or vice versa to achieve spectrum resolved confocal FLIM. According to one embodiment, the line spectral imaging unit is comprised of a line slit 122 providing the line confocal imaging, a line spectrograph 123 arranged to spatially separate the wavelength spectrum in the direction orthogonal to the line extension, a gated image intensifier 118 to provide the timed gating with respect to the pulsed light source 101, and a 2D detector unit 118 for registering the spectrally-resolved fluorescence emission from the fluorophores in the target/sample 109.

A FLIM image is normally created by taking multiple intensity images of the phosphor screen of the gated optical intensifier (GOI), in which each image is acquired after the GOI is delayed by some time t₁ relative to the excitation pulse. For example from seven intensity images at t₁=0 ns, t₂=1 ns, t₃=2 ns, . . . , t₇=6 ns. For each pixel position in image i, the decreasing image intensity values will be I₁, I₂, I₃, . . . I₇. The data for each pixel position are then fit to a model to evaluate a lifetime. For example, the model can be a simple single exponential function Iᵢ=Iᵢ(0) EXP(−tᵢ/τ), where Iᵢ(0) is the pixel intensity at zero delay and tau is the sample fluorescence lifetime at the corresponding pixel position. The fitting model may be more complex, as with multi-exponential, stretched exponential, etc. A typical image has about 1 million pixels. If all pixels are to be fit to the model, the amount of data processing becomes very large and slow. It is desirable to limit the data fitting only to regions of interest (ROI). The ROIs ca be where cell bodies or specific organelles (objects) exist. In this way the number of pixels to be processed can be significantly decreased to allow fast on-line data fitting. Further, to speed the acquisition, the system may be used to scan only over ROIs. Further, the multiple data I₁, I₂, I₃, . . . I₇, for each pixel can be stored in a buffer for on-line processing before storage in a system hard drive. To achieve all this, the invention proposes a first image (e.g., Iᵢ(0)) of the full sample as a preliminary scan. The invention requires fast on-line analysis of the image to identify the pixels of the ROI by masking out the unwanted pixels. For analysis, one may use systems such as the Investigator software tool offered by GE Healthcare. The masking can be at the level of image acquisition where for example the FLIM scanning takes places over areas of interest (e.g., highest number of ROI per scan area), or over at the level of image analysis, where analysis becomes limited to pixels of the ROI, or preferably both.

High content analysis (HCA) is an activity currently performed on intensity-based cellular images. By HCA is meant extraction of a large number of data from the images. For example, upward of ten to several tens of measured values can be extracted for each object in an image. The measures can be number-, intensity-, and or shape-based (morphology). One is then interested to know which of the measured are significantly influenced by biological modulation, as in dose-dependent drug addition. These will then constitute the phenotypes of interest for further investigation. Statistical techniques such as multivariate analysis may be used to discover previously unrecognized cellular phenotypes. This invention proposes addition of lifetime and morphology data from FLIM images to those obtained from the intensity images. In this way, the system enables discovery of even more cellular phenotypes.

The presently preferred embodiments of the invention are described with reference to the drawings, where like components are identified with the same numerals. The descriptions of the preferred embodiments are exemplary and are not intended to limit the scope of the invention.

Although the present invention has been described above in terms of specific embodiments, many modification and variations of this invention can be made as will be obvious to those skilled in the art, without departing from its spirit and scope as set forth in the following claims.

What is claimed is:

1. A confocal fluorescence lifetime imaging (FLIM) system comprising a pulsed tuneable excitation light source arranged to provide excitation radiation to an illumination area on a target, scanning means for scanning the illumination area across the target, and at least one detector for detecting fluorescent emission from the target,
wherein the pulsed light source comprises a line forming unit arranged to form a line shaped illumination area of pulsed excitation light on the target, and wherein the detector comprises shutter means arranged to operate in synchronization with the pulsed light source enabling detection of time-resolved fluorescence intensity from the target.

2. The confocal FLIM system of claim 1, wherein the shutter means is a gated image intensifier.

3. The confocal FLIM system of claim 1, wherein the scanning means is arranged to translate the sample.

4. The confocal FLIM system of claim 1, wherein the scanning means is a scanning unit arranged to optically scan the line shaped illumination area across the sample and wherein the detector comprises a two dimensional sensor unit operated in a rolling line shutter mode in synchronization with the scanning unit.

5. The confocal FLIM system of claim 1, wherein the pulsed tuneable excitation light source is a pulsed supercontinuum laser and a wavelength tuning unit.

6. The confocal FLIM system of claim 1, wherein the detector comprises a line spectral imaging unit for providing spectrum resolved FLIM.
